(19) United States
(12) Patent Application Publication
(10) Pub. No.: US 2013/0185305 A1
(43) Pub. Date: Jul. 18, 2013

(54) KEYWORD ASSIGNMENT APPARATUS AND RECORDING MEDIUM

(71) Applicant: Olympus Corporation, Tokyo (JP)

(72) Inventor: Emi KUROKAWA, Tachikawa-shi (JP)

(73) Assignee: OLYMPUS CORPORATION, Tokyo (JP)

(21) Appl. No.: 13/787,794

(22) Filed: Mar. 6, 2013

Related U.S. Application Data
(63) Continuation of application No. PCT/JP2011/069603, filed on Aug. 30, 2011.

(30) Foreign Application Priority Data
Sep. 7, 2010 (JP) 2010-200247

(51) Int. Cl. G06F 17/30

(52) U.S. Cl. CPC G06F 17/30598
USPC 707/740

(57) ABSTRACT

A keyword assignment apparatus includes a feature value extraction unit, a classification unit, a classification frequency measurement unit, and a keyword assignment unit. The feature value extraction unit is configured to extract a feature value vector, which consists of feature values, from an input image. The classification unit is configured to perform classification to the feature value vector extracted by the feature value extraction unit. The classification frequency measurement unit is configured to measure a frequency of the classification classified by the classification unit. The keyword assignment unit is configured to assign keywords to the input image based on the classification classified by the classification unit and the frequency measured by the classification frequency measurement unit.

### CROSS REFERENCE TO RELATED APPLICATIONS

This application is a Continuation Application of PCT Application No. PCT/JP2011/069603, filed Aug. 30, 2011 and based upon and claiming the benefit of priority from prior Japanese Patent Application No. 2010-200247, filed Sep. 7, 2010, the entire contents of all of which are incorporated herein by reference.

### BACKGROUND OF THE INVENTION

1. Field of the Invention

The present invention relates to a keyword assignment apparatus that extracts feature values of an image, identifies the image based on the feature values, and automatically assigns a keyword, and to a recording medium having a program, which allows a computer to function as such a keyword assignment apparatus, recorded therein.

2. Description of the Related Art

In recent years, with realization of capacity enlargement and price reduction of a recording medium such as a memory, there is a tendency that large quantities of images captured by a digital camera are stored in the digital camera. Further, such captured images are transferred to and stored in an external device, for example, a personal computer. Furthermore, in such an external device, not only images captured by a user utilizing the digital camera but also images collected through the Internet are stored.

Therefore, when a keyword is previously given to each image and keyword retrieval is performed, a user can easily search for his/her desired image from large quantities of images stored in the digital camera or the external device. If this keyword is assigned every time the user captures or collects an image, little trouble is entailed. However, keywords must be sequentially assigned to large quantities of already captured or collected images, and this operation is very troublesome and requires much time.

Thus, for example, Japanese Patent. No. 3683481 suggests a technique that enables automatically assigning keywords. According to this technique, an image that is similar to an image which is a keyword assignment target is retrieved and extracted, and a keyword assigned to this extracted similar image is also assigned to the target image.

### BRIEF SUMMARY OF THE INVENTION

According to a first aspect of the invention, there is provided a keyword assignment apparatus comprising:

a feature value extraction unit configured to extract a feature value vector, which consists of feature values, from an input image;

a classification unit configured to perform classification to the feature value vector extracted by the feature value extraction unit;

a classification frequency measurement unit configured to measure a frequency of the classification classified by the classification unit; and

a keyword assignment unit configured to assign keywords to the input image based on the classification classified by the classification unit and the frequency measured by the classification frequency measurement unit.

According to a second aspect of the invention, there is provided a recording medium which records therein in a non-transitory manner:

a code which allows a computer to extract a feature value vector, which consists of feature values, from an input image;

a code which allows the computer to perform classification with respect to the extracted feature value vector;

a code which allows the computer to measure a frequency of the classified classification; and

a code which allows the computer to assign keywords to the input image based on the classified classification and the measured frequency.

Advantages of the invention will beset forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of a digital camera to which a keyword assignment apparatus according to a first embodiment of the present invention is applied;

FIG. 2 is a view showing a flowchart for explaining an operation of the digital camera to which the keyword assignment apparatus according to the first embodiment is applied;

FIG. 3 is a view showing an example of a distribution of learning data in a feature space;

FIG. 4A is a view showing an example of a classification tree corresponding to classification in FIG. 3;

FIG. 4A is a view showing another example of a classification tree corresponding to classification in FIG. 3;

FIG. 5 is a view showing an example of a classification result for images captured by a user;

FIG. 6 is a view showing a classification frequency in the example of FIG. 5;

FIG. 7 is a view showing an example of a classification result for images captured by a user who likes animals;

FIG. 8 is a view showing a classification frequency in the example of FIG. 7;

FIG. 9 is a view showing a result of performing classification correction with respect to the classification result in the example of FIG. 7;

FIG. 10 is a view showing a classification frequency in the classification correction result of FIG. 9;

FIG. 11 is a view showing a result of further performing the classification correction with respect to the classification correction result in the example of FIG. 9;

FIG. 12 is a view showing a classification frequency in the classification correction result of FIG. 11;

FIG. 13 is a view showing a display output example;

FIG. 14 is a view showing a configuration of a digital camera to which a keyword assignment apparatus according to a modification of the first embodiment of the present invention is applied; and

FIG. 15 is a view showing a configuration of a digital camera to which a keyword assignment apparatus according to a second embodiment of the present invention is applied.

### DETAILED DESCRIPTION OF THE INVENTION

Modes for carrying out the present invention will now be described hereinafter with reference to the drawings.

### First Embodiment

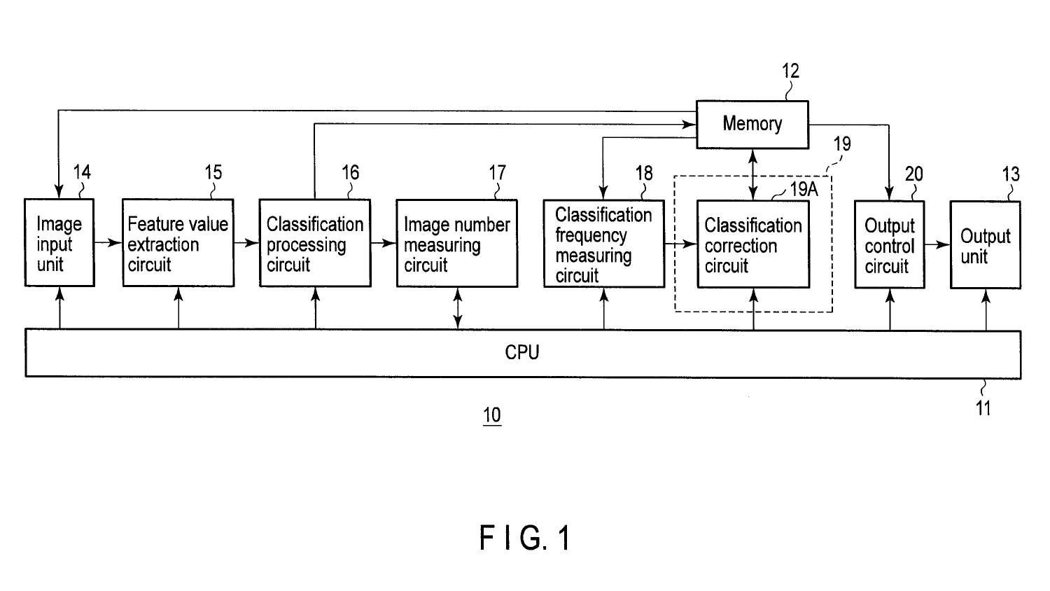

As shown in FIG. 1, a digital camera 10 to which a keyword assignment apparatus according to a first embodiment of the present invention is applied includes a CPU 11, a memory 12, an output unit 13, an image input unit 14, a feature value extraction circuit 15, a classification processing circuit 16, an image number measuring circuit 17, a classification frequency measuring circuit 18, a keyword assignment circuit 19, and an output control circuit 20. Here, the keyword assignment circuit 19 has a classification correction circuit 19A.

The CPU 11 controls the entire digital camera 10. The memory 12 is a recording medium that stores shot images. The output unit 13 is, for example, a liquid crystal monitor configured to display the images recorded in the memory 12 or so-called through images. It should be noted that a configuration for shooting images is well-known, and hence a description and drawings thereof will be omitted.

The image input unit 14 is connected to the CPU 11, the memory 12, and the feature value extraction circuit 15. The feature value extraction circuit 15 is connected to the CPU 11 and the classification processing circuit 16. The classification processing circuit 16 is connected to the CPU 11, the memory 12, and the image number measuring circuit 17. The image number measuring circuit 17 is connected to the CPU 11. The classification frequency measuring circuit 18 is connected to the CPU 11, the memory 12, and the classification correction circuit 19A of the keyword assignment circuit 19. The classification correction circuit 19A of the keyword assignment circuit 19 is connected to the CPU 11 and the memory 12. The output control circuit 20 is connected to the CPU 11, the memory 12, and the output unit 13.

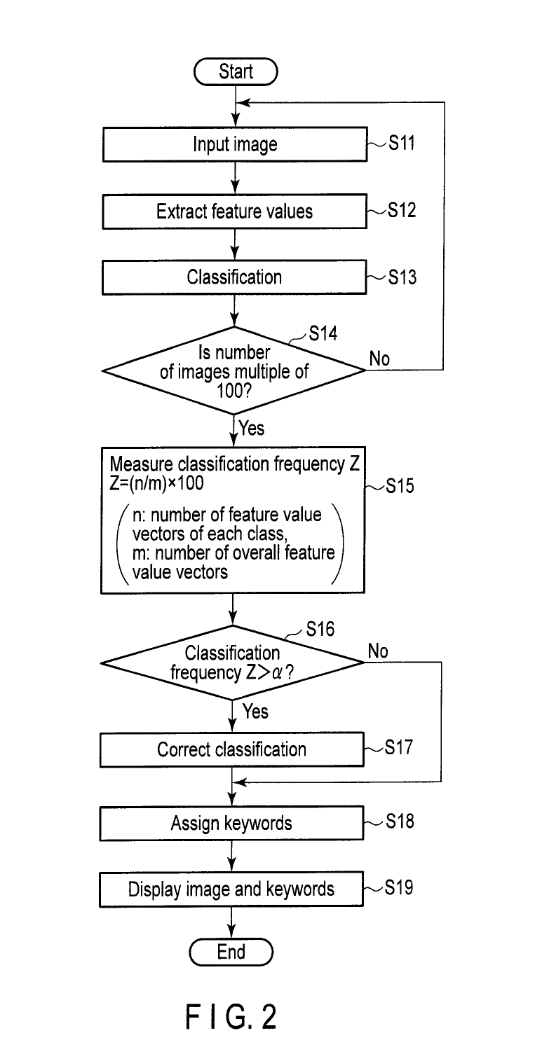

An operation in such a configuration will now be described hereinafter with reference to a flowchart of FIG. 2.

The CPU 11 allows the image input unit 14 to read an image, which is a keyword assignment target, from the memory 12 and input the read target image to the feature value extraction circuit 15 that functions as, for example, feature value extraction unit (step S11). Then, the CPU 11 allows the feature value extraction circuit 15 to extract feature values (i.e., a feature value vector) from the input image and input the extracted feature values (the extracted feature value vector) to the classification processing circuit 16 that functions as, for example, class classifying unit (step S12).

Subsequently, the CPU 11 allows the classification processing circuit 16 to perform classification of the extracted feature value vector, which consists of the extracted feature values, in a feature space, add a classification result to the corresponding target image in the memory 12, and input an end signal to the image number measuring circuit 17 (step S13). Here, as the addition of the classification result to the target image, the classification result may be recorded in a table and thereby associated with the target image. However, considering transfer or the like of the target image to an external device such as a personal computer, it is desirable to add the classification result in such a manner that this result can be integrally moved or deleted with the image in the form of addition to a file header (for example, Exif information) of the target image.

Here, the classification will now be explained in detail.

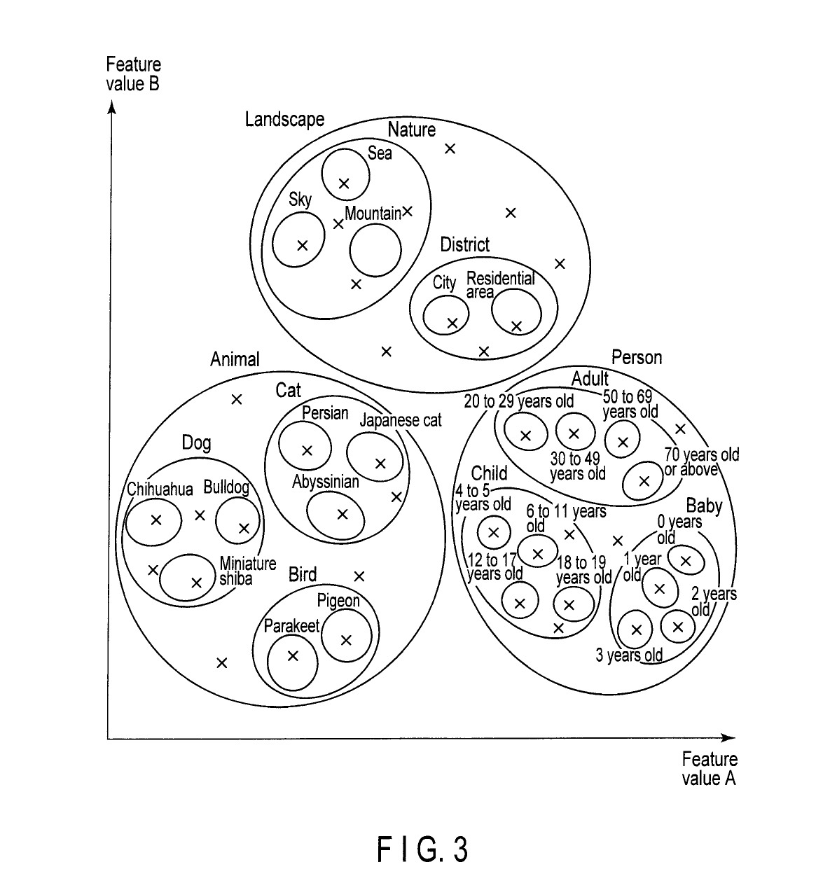

The classification processing circuit 16 has already learned preset classification. In this learning process, images (learning data) having appropriate keywords assigned thereto by a person are first prepared, feature values are (a feature value vector is) extracted from each of these images, and the extracted feature values are input to the classification processing circuit 16. Here, as the feature value, it is possible to use any feature value suitable for classification of the learning data from various feature values included in the image itself or various feature values added to the image. Here, the feature values included in the image include a hue, chroma, luminance, a shape, a size, a position, and others. Moreover, the feature values added to the image include ISO sensitivity included in the Exif information and others. It should be noted that the feature value extraction circuit 15 is configured to extract the feature values adopted in this learning process. Additionally, the classification processing circuit 16 arranges the feature values (the feature value vector) of input images (the learning data) in a feature space as shown in FIG. 3 and forms classification boundaries so that the images having the same keyword assigned thereto can be classified into the same class in the feature space. Although any technique may be used for this classification, for example, a k-approximation method is used. In FIG. 3, each mark x corresponds to each learning data, and each closed region represents a classification boundary of a class corresponding to each keyword. It should be noted that the feature space in FIG. 3 is just shown as a two-dimensional space for simplification, and it is actually an N-dimensional space. Here, N represents an arbitrary natural number.

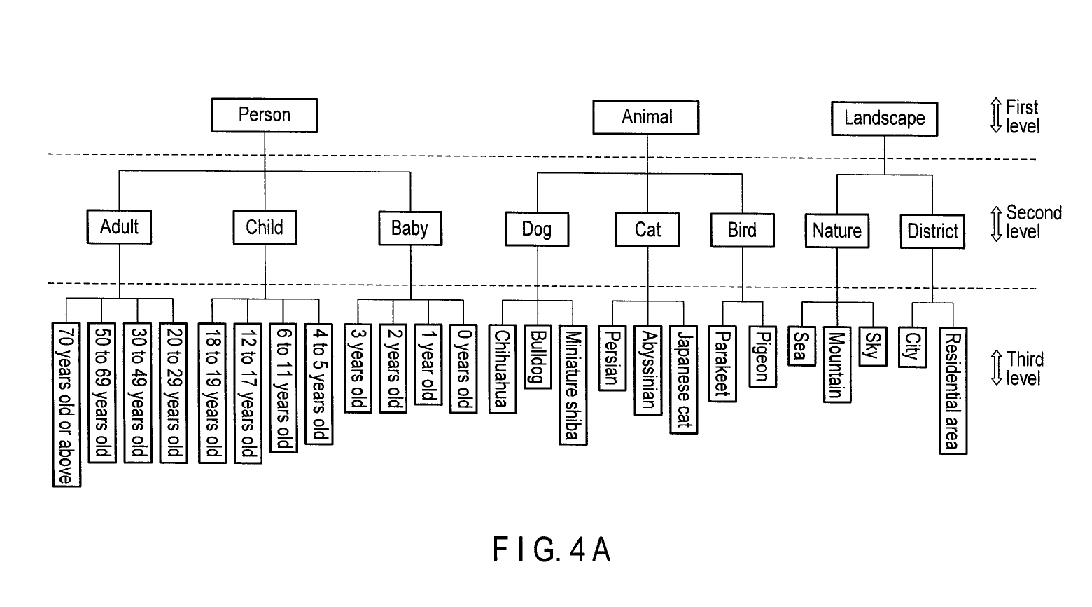

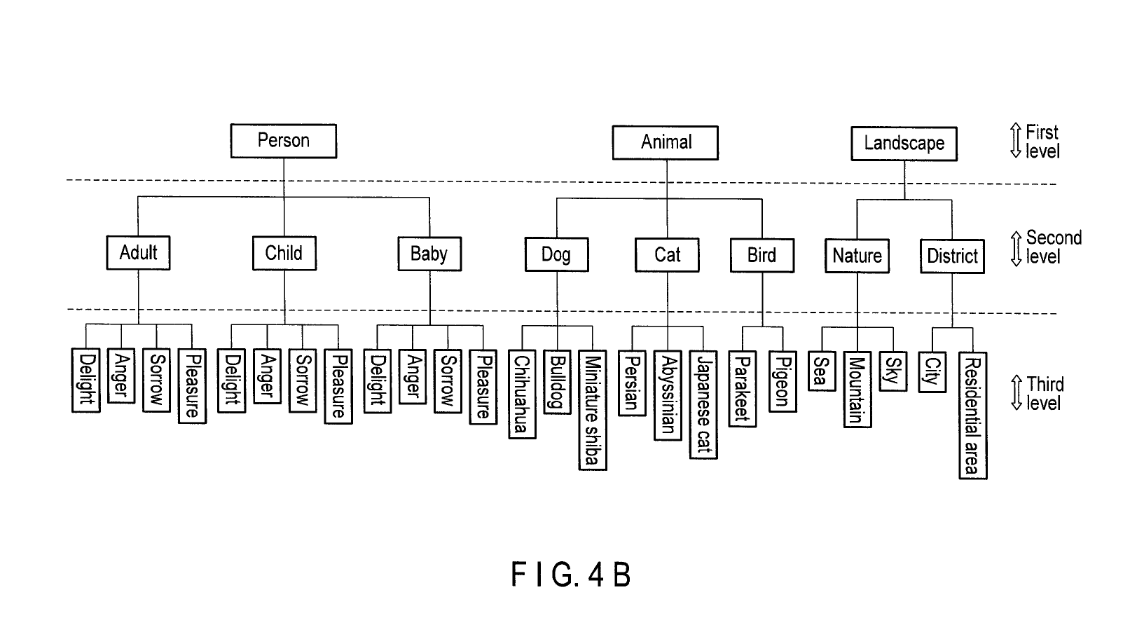

Further, keywords assigned to images by a person has such a hierarchical structure as shown in FIG. 4A or FIG. 4B, and keywords in upper levels occupy a larger region in the feature space and include regions of keywords in lower levels. It should be noted that a classification true shown in FIG. 4A or FIG. 4B is just an example, and the keywords or the number of levels are not restricted thereto as a matter of course.

The classification processing circuit 16 performs classification with respect to feature values (a feature value vector) of a keyword assignment target image input from the feature value extraction circuit 15 based on the thus learned classification boundaries classes under control of the CPU 11. That is, when the feature values (the feature value vector) of the target image are (is) included in any closed region in the feature space, this image is classified into a class corresponding to this closed region. It should be noted that, in the initial state, classes in the highest level (a first level) are classified. When the processing for one keyword assignment target image is finished, the classification processing circuit 16 inputs an end signal to the image number measuring circuit 17.

The image number measuring circuit 17 measures how many keyword assignment target images have been processed by using the end signal input from the classification processing circuit 16. The CPU 11 determines whether a predetermined number of target images, which are the target images whose number is a multiple of 100 in this example, have been processed based on a measurement result of this image number measuring circuit 17 (step S14). If the target images whose number is a multiple of 100 have not been processed yet, the control returns to step S11, and processing for the next target image is carried out.

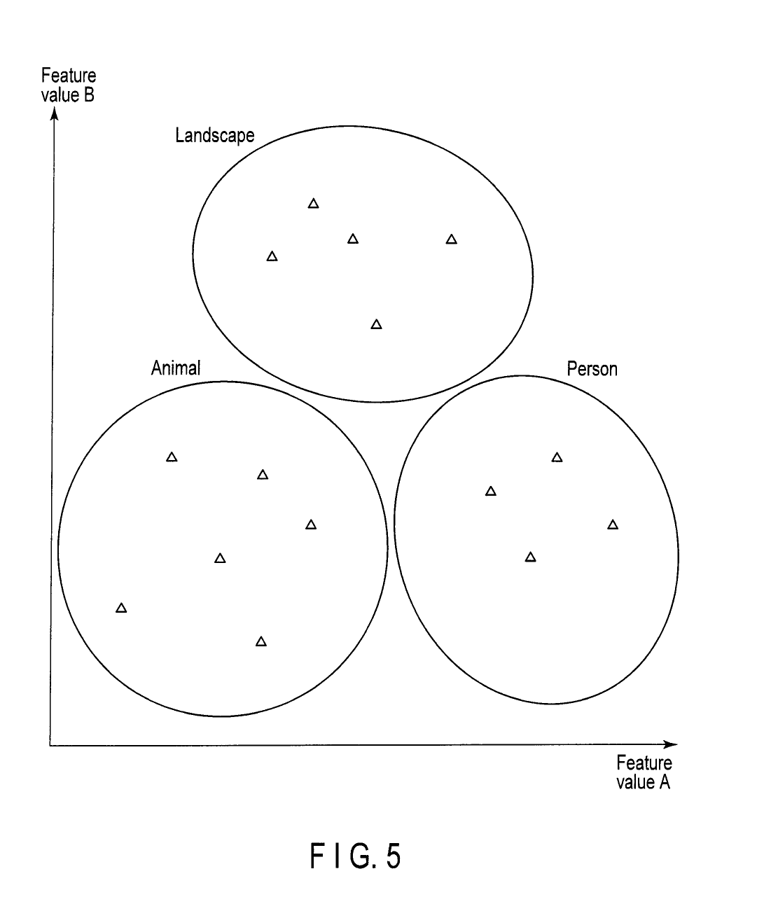

In this mariner, the target images shot by a user are subjected to the classification. As a result, as shown in FIG. 5, a classification result for the images shot by the user can be obtained. In FIG. 5, each mark Δ corresponds to feature values, or a feature value vector, of the each image shot by the user.

It should be noted that the number of feature values extracted from one image is not restricted to one feature value vector, and more feature values (feature value vectors) may be possibly extracted. Further, the extracted feature vectors (the extracted feature value vectors) may be classified into the same class or may be classified into multiple classes. It should be noted that, in the latter case, keywords are assigned to one image at the same time.

Furthermore, in step S14, when it is determined that the target images whose number is a multiple of 100 have been processed, the CPU 11 allows the classification frequency measuring circuit 18, which functions as, for example, classification frequency measuring unit, to measure a classification frequency Z of each class from the images which are stored in the memory and have been already subjected to the classification (step S15). For example, in the classification frequency measuring circuit 18, assuming that m [quantities] is the number of all feature value ctors of all images which have been already subjected to the classification and n [quantities] is the number of feature value vectors in each class, and a classification frequency Z [%] is measured in accordance with each class based on the following expression:

Z=100×n/m

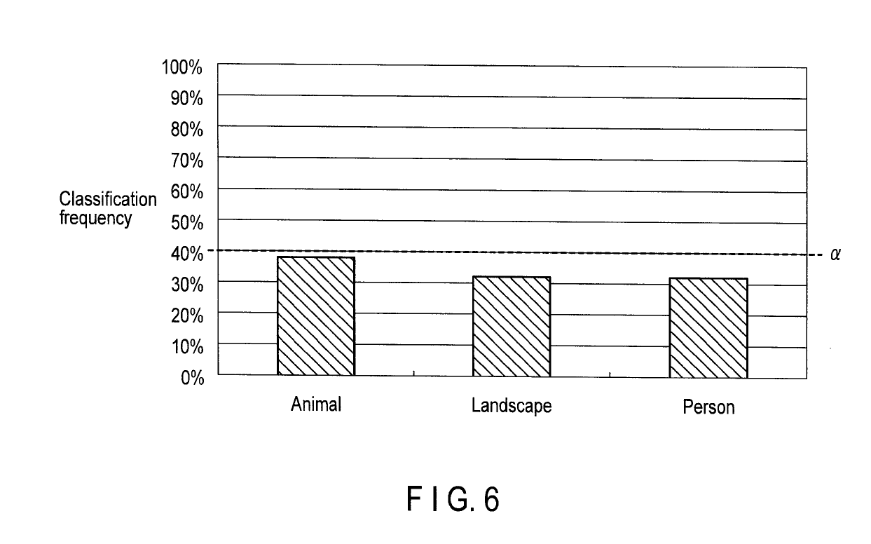

FIG. 6 is a graph showing each classification frequency in FIG. 5. The thus measured classification frequency of each class is input to the classification correction circuit 19A that functions as, for example, classification correction unit in the keyword assignment circuit 19 that functions as, for example, keyword assignment unit.

Then, the CPU 11 allows the classification correction circuit 19A of the keyword assignment circuit 19 to determine whether a classification frequency is not less than a predetermined value α in accordance with each class (step S16). As a value of this α, a value larger than an average value of classification frequencies of all classes is preferable. If there is a class whose classification frequency is not less than α, the CPU 11 allows the classification correction circuit 19A to execute classification correction processing to this class (step S17). The processing in step S17 is skipped with respect to a class having a classification frequency that is not greater than or equal to e, and the CPU 11 allows the classification correction circuit 19A to assign a corresponding keyword to each class (step S18).

In the example of FIG. 6, if there is no bias for a specific number of shot images depending on the classes and the predetermined value α=40 is achieved, there is no class having a classification frequency Z greater than or equal to α, and hence the classification correction is not carried. Therefore, the classes remain in the first level in FIG. 4A or FIG. 4B without being classified. Accordingly, a keyword “animal”, “landscape”, or “person” is assigned to each image that is stored in the memory 12 and has been subjected to the classification in accordance with each classified class. With regard to assigning the keyword to each target image, like the above-described addition of the classification result, it is desirable to add the keyword in such a manner that the keywords can be moved or deleted integrally with each image in the form of addition to a file header (for example, Exif information) of the target image. Further, here, to give clear explanations, the classification result and the keyword are described by using the same terminology, and any expressions that can be discriminated from each other, for example, “0001”, “0002”, and others can be used as classification results.

Consequently, when an instruction for displaying an arbitrary image or an instruction for displaying an image based on keyword retrieval is issued by a user operation in a non-illustrated instruction input unit, the CPU 11 allows the output control circuit 20, which functions as, for example, display controlling unit, to read a corresponding image and a keyword assigned to this image from the memory 12, and the image and the keyword can be displayed in the output unit 13, for example (step S19).

On the other hand, for example, in case of a user who likes animals, the number of images of animals captured by the digital camera 10 increases, and hence there is a bias for specific images depending on each user's interest or taste in this manner.

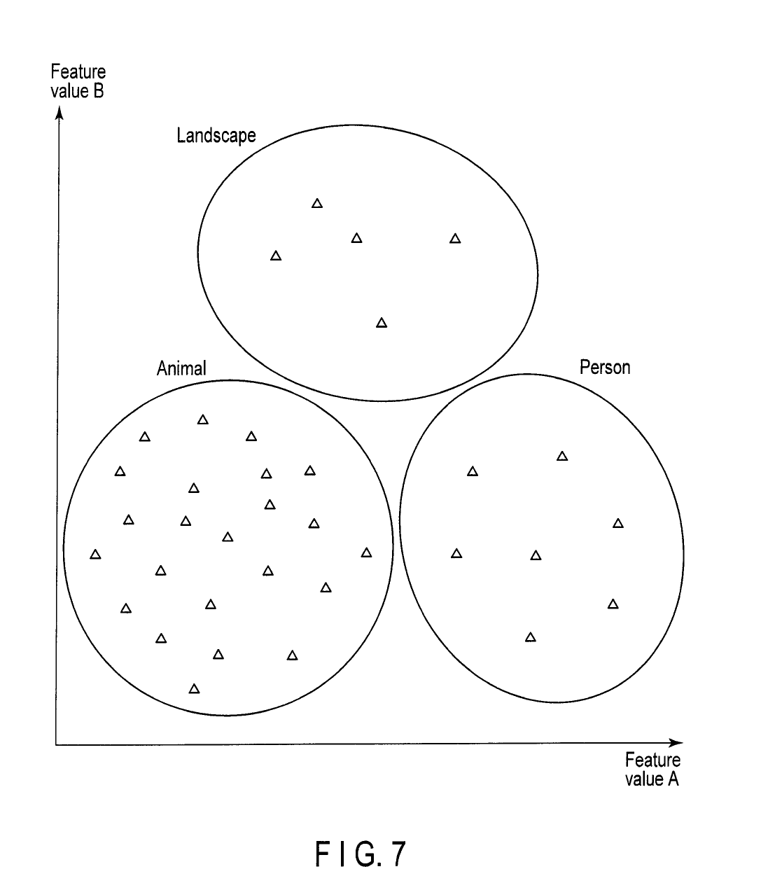

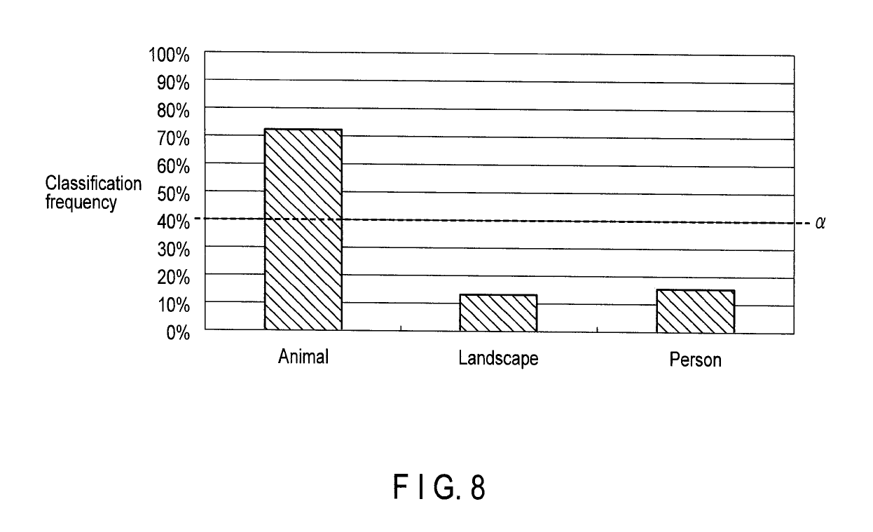

FIG. 7 shows an example of a classification result when the number of shot images of animals is high, and FIG. 8 is a view showing classification frequencies in this classification result of FIG. 7 in the form of a graph. In this case, as shown in FIG. 8, a classification frequency Z becomes α=40 or above. Therefore, it can be determined that there is a class whose classification frequency is greater than or equal to α in step S16, and hence the CPU 11 allows the classification correction circuit 19A to execute the classification correction processing with respect to this class in step S17.

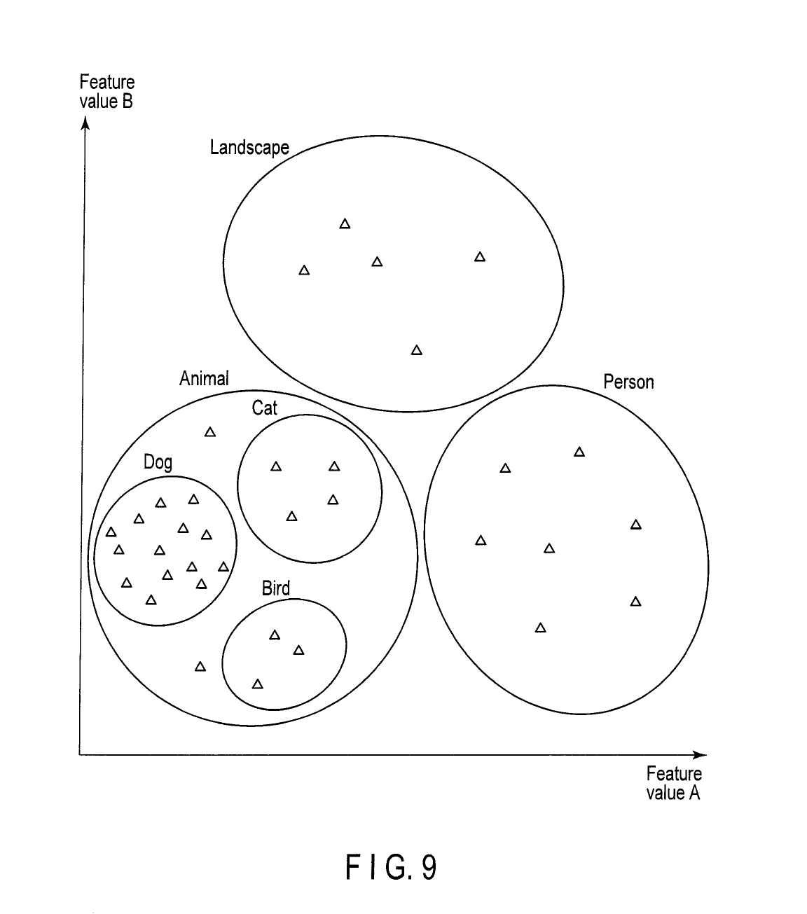

Like the classification processing circuit 16, the classification correction circuit 19A has also learned preset classification in advance based on such learning data as shown in FIG. 3. Further, based on a result of previous learning, as shown in FIG. 9, classification boundaries “dog”, “cat”, and “bird” are added in the class “animal”, each of all images classified into the class “animal” in the memory 12 is determined as a target image, and classification correction for again performing the classification is carried out. Furthermore, this classification correction result is added to each target image. As this addition of the classification correction result, the classification of the first level that has been already added to each target image may be updated to classification of a second level. However, since each target image can be retrieved by using various keywords, a system that adds the classification in the second level to the classification in the first level is more preferable.

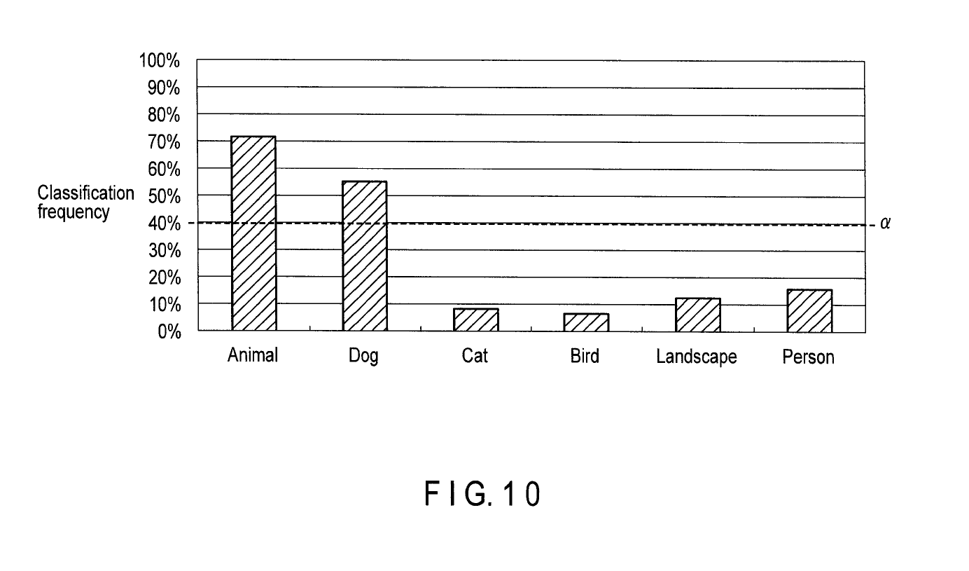

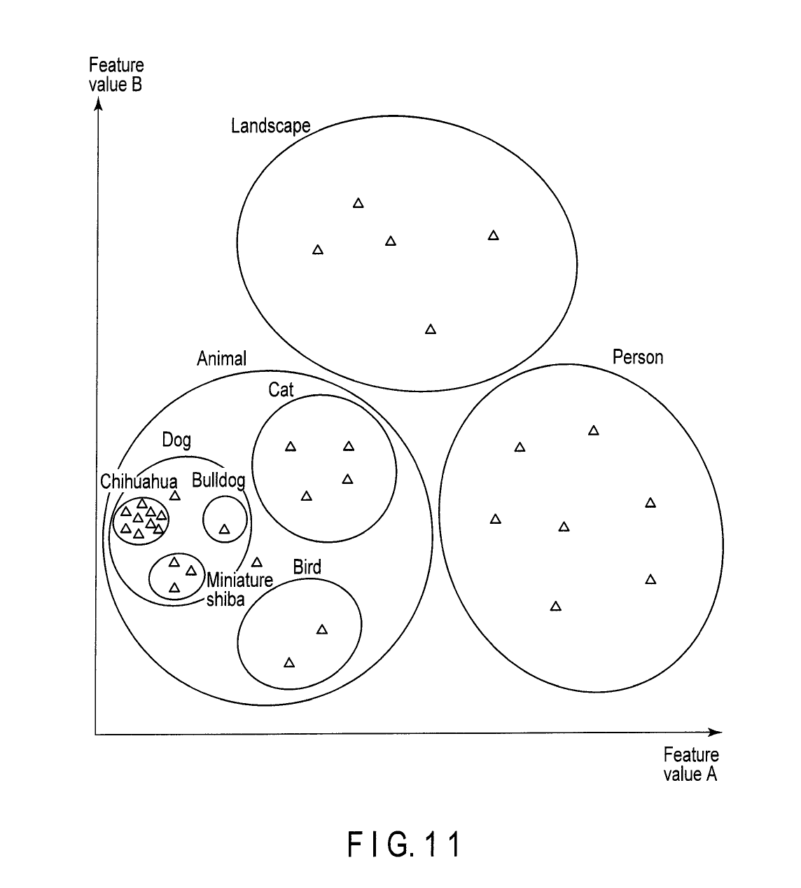

FIG. 10 is a view showing each classification frequency in the classification correction result of FIG. 9 in the form of a graph. In this case, as shown in FIG. 10, a classification frequency Z of “dog” is α=40 or above, and hence the classification correction processing is further performed with respect to this class. That is, based on the result of the previous learning (FIG. 3), as shown in FIG. 11, classification boundaries “chihuahua”, “bulldog”, and “miniature shiba” are added in the class “dog”, each of images classified into the class “dog” in the memory 12 is determined as a target image, the classification correction for again performing the classification is carried out. Further, a result of this classification is added to each target image. In regard to this addition of the classification correction result, it is preferable to adopt a system that adds classification of the third level to the classification of the first and second levels which has been already added to each target image.

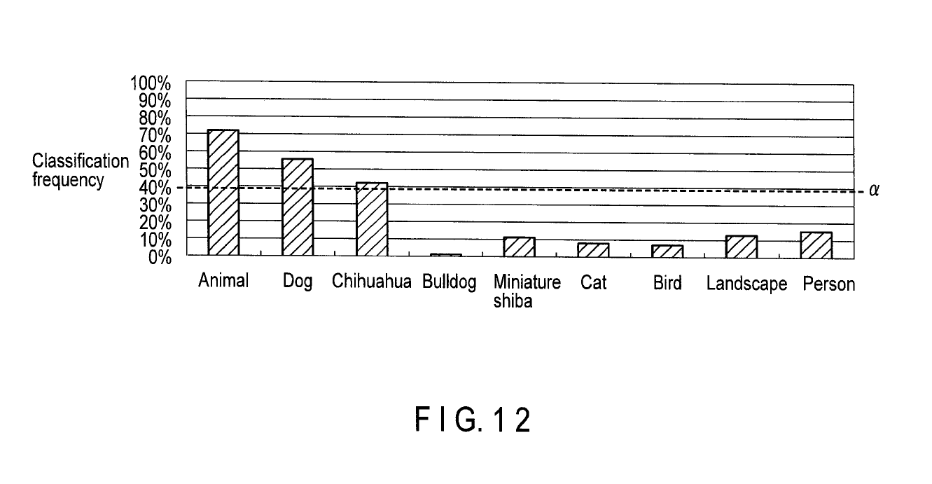

FIG. 12 is a view showing each classification frequency in this classification correction result of FIG. 11 in the form of a graph. It should be noted that, as shown in FIG. 12, although a classification frequency Z of “chihuahua” is α=40 or above but, in this embodiment, only the three levels have been hierarchized learned, and hence further classification correction is not carried out. Needless to say, a user can set classification of lower levels through the non-illustrated instruction input unit or he/she can download classification of lower levels from the Internet through a non-illustrated communication unit and set the downloaded classification so that further classification correction can be effected.

When the classification is corrected in this manner, the CPU 11 allows the classification correction circuit 19A to assign a corresponding keyword to each class in step S18. For example, in the example of FIG. 11, three keywords “animal”, “dog”, and “chihuahua” are assigned to each image classified into the class “chihuahua”. Further, two keywords “animal” and “dog” are assigned to each image which is not classified into all of the “chihuahua”, “bulldog”, and “miniature shiba” but classified into the class “dog”.

As described above, each class is classified as a class in the first level when its classification frequency Z is less than α, and lower levels are released and the classification is sequentially corrected when each class has the classification frequency Z greater than or equal to α. Further, a keyword corresponding to this classified class is assigned to each image.

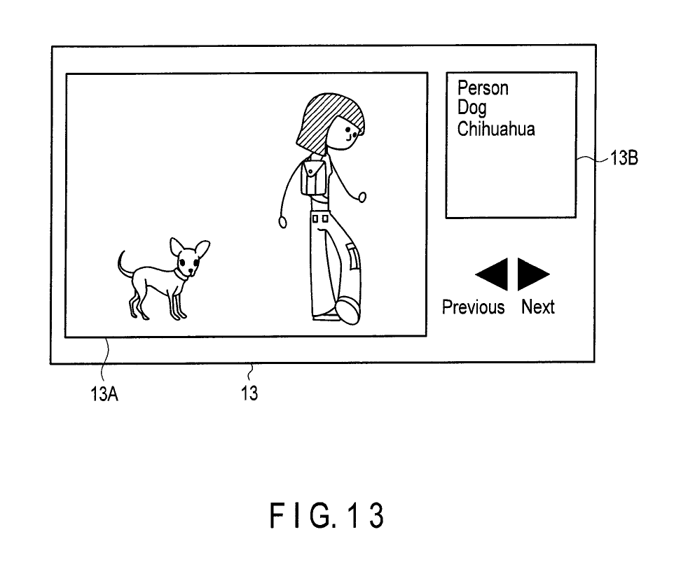

It should be noted that display and output of an image and a keyword with respect to the output unit 13 in step S19 are carried out as shown in, for example, FIG. 13. That is, the output unit 13 is constituted of an image display unit 13A and a keyword display unit 13B.

Here, the keyword display unit 13B displays each keyword corresponding to each classified class in the lowest level. In an example shown in FIG. 11, if an image is a picture of a chihuahua, “animal”, “dog”, and “chihuahua” are added as keywords, and the output control circuit 20 reads “chihuahua” in these keywords and displays it in the keyword display unit 13B. Furthermore, and an image is a picture of a giraffe, “animal” alone is added as a keyword, this is the only keyword corresponding to a class in the lowest level, and hence the output control circuit 20 reads this “animal” and displays it in the keyword display unit 13B.

Moreover, the keyword display unit 13B may be configured to display n keywords (for example, “dog” and “chihuahua” if n=2) corresponding to classes in n levels from the lowest level. Additionally, this unit may be configured to display all keywords (for example, “animal”, “dog”, and “chihuahua”) corresponding to classified classes in all the levels.

Alternatively, a user may be enabled to select one from the three types of keyword display conformations through a non-illustrated instruction input unit.

Further, when each image is classified into multiple classes, the output control circuit 20 reads keywords corresponding to the respective classes and displays them in the keyword display unit 13B. For example, in case of an image obtained by shooting a child and a chihuahua, if the display conformation for displaying two keywords corresponding to classes in two levels from the lowest level is selected, the keyword display unit 13B displays “person”, “dog”, and “chihuahua” like the example of FIG. 13.

It should be noted that the output unit 13 may display the image display unit 13A and the keyword display unit 13B as windows in one liquid crystal display.

Alternatively, it is possible to adopt a display conformation for switching and displaying an image and keywords instead of displaying an image and keywords in the independent display units or windows.

As described above, according to the first embodiment, a frequency of the classification assigned to feature values extracted from an image is analyzed, and the classification is corrected so that an image having a high classification frequency assigned thereto can be classified into a more detailed class. As a result, it is possible to assign keywords meeting a user's interest or a collection tendency in shooting subjects.

[Modification]

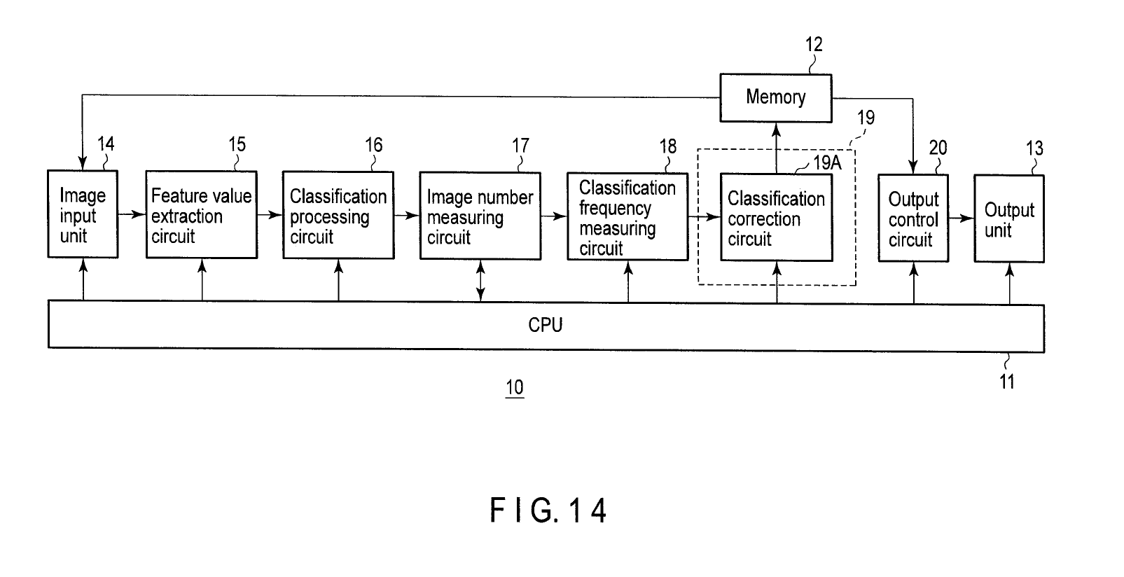

In this modification, as shown in FIG. 14, the classification processing circuit 16 is connected to the CPU 11 and the image number measuring circuit 17. The image number measuring circuit 17 is connected to the CPU 11 and the classification frequency measuring circuit 18. The classification frequency measuring circuit 18 is connected to the CPU 11 and the classification correction circuit 19A of the keyword assignment circuit 19. Other structures are equal to those in the first embodiment.

In the first embodiment, the classification processing circuit 16 adds a classification result to each image stored in the memory 12, and the classification correction circuit 19A corrects the classification. On the other hand, in this modification, target images read by the image input unit 14 are sequentially input to the subsequent circuit, whereby the addition of a classification result and the processing of classification correction or the like are carried out with respect to each of these images. Therefore, in this modification, each of the image number measuring circuit 17, the classification frequency measuring circuit 18, and the classification correction circuit 19A includes an internal memory having a certain level of capacity (for example, 100 or more images).

That is, in step S12, the CPU 11 allows the feature value extraction circuit 15 to extract feature values (a feature value vector) from each input target image and input the extracted feature values and the target image to the classification processing circuit 16.

Then, in step S13, the CPU 11 allows the classification processing circuit 16 to perform the classification with respect to the extracted feature values (the extracted feature value vector) in the feature space, add a result of this classification to the target image input from the feature value extraction circuit 15, and input the target image having the classification result added thereto to the image number measuring circuit 17.

The image number measuring circuit 17 has a function of storing each input target image having the classification result added thereto and counting the number of the stored target images. Therefore, in step S14, the CPU 11 determines whether a predetermined number of target images, which are the target images whose number is a multiple of 100 here, have been processed based on a counting result of this image number measuring circuit 17. If the target images whose number is a multiple of 100 have not been processed yet, the control returns to step S11, and the processing for a subsequent target image is carried out.

Furthermore, if it is determined that the target images whose number is a multiple of 100 have been processed in step S14, the CPU 11 transfers the images, each of which is stored in the internal memory of the image number measuring circuit 17 and has the classification result added thereto, to the internal memory of the classification frequency measuring circuit 18 and allows the classification frequency measuring circuit 18 to measure a classification frequency Z of each class from these images in step S15.

Then, in step S16, the CPU 11 transfers the images, each of which is stored in the internal memory of the classification frequency measuring circuit 18 and has the classification result added thereto, to the internal memory of the classification correction circuit 19A and allows the classification correction circuit 19A to determine whether the classification frequency of each class is greater than or equal to the predetermined value a. Furthermore, if there is a class having a classification frequency greater than or equal to a, the CPU 11 allows the classification correction circuit 19A to execute the classification correction processing to this class (step S17). This processing of step S17 is skipped with respect to each class having the classification frequency which is not greater than or equal to a, and the CPU 11 allows the classification correction circuit 19A to assign a corresponding keyword to each class, replaces each image having the keyword assigned thereto with a corresponding image stored in the memory 12, and stores the replaced image (step S18).

In the example of FIG. 6, if there is no bias for a specific number of shot images depending on the classes and the predetermined value α=40 is achieved, there is no class having a classification frequency Z greater than or equal to α, and hence the classification correction is not carried. Therefore, the classes remain in the first level in FIG. 4A or FIG. 4B, and a keyword “animal”, “landscape”, or “person” is assigned to each classified image stored in the internal memory of the classification correction circuit 19A in accordance with a class into which this image is classified. In regard to assigning the keyword to each target image, as described in the first embodiment, like the addition of the classification result, it is desirable to add the keyword in such a manner that the keyword can be moved or deleted integrally with each image in the form of addition to a file header (for example, Exif information) of the target image, or the classification result may be substituted by the keyword.

Moreover, in the example of FIG. 8, since the classification frequency Z of “animal” is α=40 or above, as described in the first embodiment, the classification correction circuit 19A executes the classification correction processing with respect to this class. Additionally, a keyword is assigned to each image subjected to this classification correction in accordance with the classified class subjected to the correction. For instance, in the example of FIG. 11, three keywords “animal”, “dog”, and “chihuahua” are assigned to an image classified into the class “chihuahua”. Furthermore, two keywords “animal” and “dog” are assigned to an image that is not classified into all of “chihuahua”, “bulldog”, and “miniature shiba” but classified into the class “dog”.

In this manner, the classification correction circuit 19A assigns keywords to each image stored in the internal memory thereof and substitutes the image having the keywords assigned thereto with a corresponding image stored in the memory, whereby the image is stored in the memory 12.

As described above, according to this modification, like the first embodiment, a frequency of the classification assigned to feature values extracted from each image is analyzed, and the classification is corrected so that each image having a high classification frequency assigned thereto can be classified into a more detailed class. As a result, it is possible to assign keywords meeting a user's interest or a collection tendency in shooting subjects.

### Second Embodiment

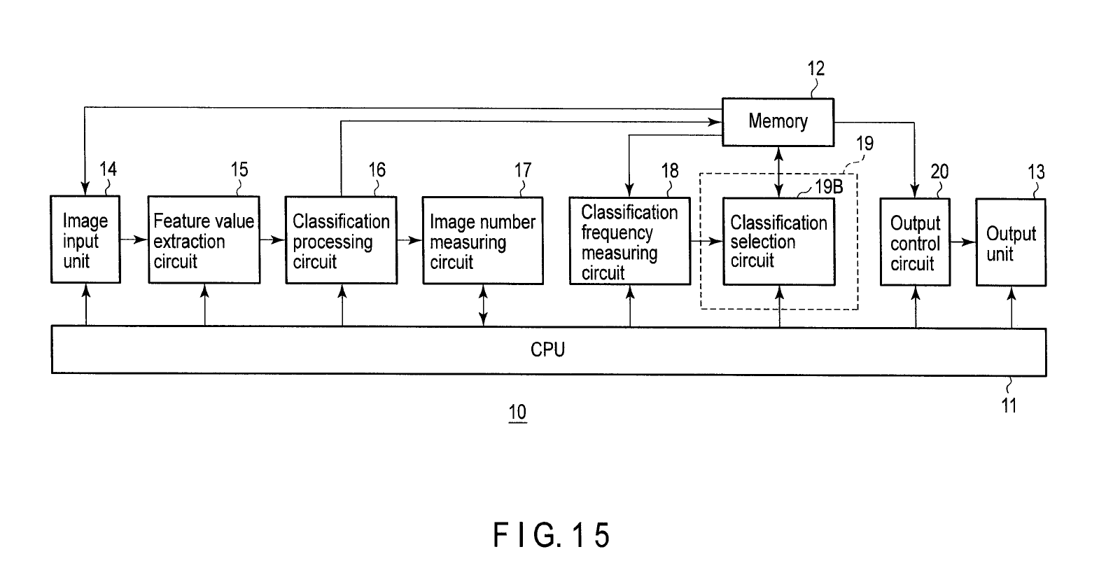

As shown in FIG. 15, in a digital camera 10 to which a keyword assignment apparatus according to a second embodiment of the present invention is applied, a keyword assignment circuit 19 includes a classification selection circuit 19B in place of the classification correction circuit 19A in the first embodiment.

Moreover, in the first embodiment, the classification processing circuit 16 performs the classification of the first level alone, and the classification correction circuit 19A in the keyword assignment circuit 19 corrects the classification as each frequency increases. On the other hand, in this embodiment, the classification processing circuit 16 performs the classification of all levels which have been learned in advance like the first embodiment with respect to each target image having keywords assigned thereto. Additionally, the classification selection circuit 19B, which functions as, for example, classification selection unit, in the keyword assignment circuit 19 selects classification of each level associated with each frequency and assigns keywords.

Therefore, the classification processing circuit 16 assigns classification results “animal”, “dog”, and “chihuahua” if a keyword assignment target image is an image obtained by shooting, for example, a chihuahua, and it assigns classification results “person”, “baby”, and “0 year old” if the keyword assignment target image is an image obtained by shooting a 0-year-old baby.

The classification selection circuit 19B in the keyword assignment circuit 19 selects which one of the classifications is to be determined as the lowest level with respect to each image in accordance with a classification frequency Z of each class measured by a classification frequency measuring circuit 18. Further, keywords based on this selection result are assigned to a corresponding image. Therefore, for example, in case of the image obtained by shooting a chihuahua, the classification “chihuahua” is selected as the lowest level, and hence keywords “animal”, “dog”, and “chihuahua” are assigned. On the other hand, in case of the image obtained by shooting a 0-year-old baby, the classification results “person”, “baby”, and “0 year old” are assigned. However, since a classification frequency Z of “person” in the first level is not α=40 or above, the first level is selected as the lowest level. Therefore, the keyword “person” alone is assigned to this image.

As described above, according to this second embodiment, the classification of the levels is carried out with respect to feature values extracted from each image, the classification is assigned, a frequency of the assigned classification is analyzed, and the classification is selected so that each image with a high classification frequency assigned thereto can be classified into a more detailed class. As a result, it is possible to assign keywords meeting a user's interest or a collection tendency in shooting subjects.

It should be noted that, in the second embodiment, the classification is added to each image stored in the memory 12, and keywords are assigned to the stored image in the memory 12 having the classification added thereto. However, needless to say, the same modification as that of the first embodiment described above can be carried nut. That is, the classification can be assigned to each target image which has been read from the memory 12 and is being processed, and each image having keywords as results assigned thereto may substitute for this image and may be stored in the memory 12.

Although the present invention has been explained based on the embodiments, the present invention is not restricted to the foregoing embodiments, and various modifications or applications can be carried out within a gist of the present invention as a matter of course.

For example, in the foregoing embodiments, the classification frequency is a ratio of the numbers of feature value vectors of each class with respect to the number of feature value vectors of all images already subjected to the classification. However, the classification frequency may be simply the number of feature value vectors of each class (the number of images) the predetermined value a in this case may be a fixed value irrespective of the overall number of shot images or may be set by a user.

Moreover, the classification correction circuit 19A in the first embodiment or the classification processing circuit 16 in the second embodiment is configured to learn all classes in the first level to the lowest level (the third level in the examples shown in FIG. 4A and FIG. 4B) in advance. However, each of these circuits may be configured to learn, for example, the first level alone in advance, and the second level and lower levels may be set by a user or downloaded from the Internet and set by the user.

Additionally, in the foregoing embodiments, the description has been given to the example where the classification is learned by using each image (learning data) to which appropriate keywords have been assigned by a person in advance. However, for example, a discriminant created from the learning data can be learned in advance, and a learning technique is not restricted.

Further, in the foregoing embodiments, the classification frequency is measured every time a predetermined number of (for example, 100) target images having keywords assigned thereto are subjected to the classification. However, when the predetermined number of target images or more images have been subjected to the classification, the classification frequency may be measured every time subsequent target image is subjected to the classification. In the latter case, the determination in step S14 can be corrected to determine whether the number of shot images is greater than or equal to a predetermined number.

Furthermore, in the foregoing embodiments, the example where the present invention is applied to the digital camera 10 has been explained. However, it is possible to supply a program of software that realizes the functions of the image input unit 14 to the keyword assignment, circuit 19 to a computer from a recording medium having this program recorded therein and allows the computer to execute this program, whereby the computer can carry out the function of assigning keywords to each image stored in the computer.

What is claimed is:

1. A keyword assignment apparatus comprising:
a feature value extraction unit configured to extract a feature value vector, which consists of feature values, from an input image;
classification unit configured to perform classification to the feature value vector extracted by the feature value extraction unit;
a classification frequency measurement unit configured to measure a frequency of the classification classified by the classification unit; and
a keyword assignment unit configured to assign keywords to the input image based on the classification classified by the classification unit and the frequency measured by the classification frequency measurement unit.

2. The apparatus according to claim 1, wherein
the keyword assignment unit comprises a classification correction unit configured to correct the classification classified by the classification unit in accordance with the frequency measured by the frequency measurement unit.

3. The apparatus according to claim 2, wherein
the classification is hierarchized, and
the classification correction unit performs the classification in a level including a classification finer than the classification classified by the classification unit with respect to a class whose frequency measured by the classification frequency measurement unit is higher than a predetermined value.

4. The apparatus according to claim 3, wherein
when there is no class whose frequency measured by the classification frequency measurement unit is higher than the predetermined value, the keyword assignment unit assigns keywords corresponding to the classification classified by the classification unit to the input image.

5. The apparatus according to claim 2, wherein
when the classification is corrected by the classification correction unit, the keyword assignment unit corrects the classification and updates keywords with respect to each image subjected to the ossification other than the input, image.

6. The apparatus according to claim 1, wherein
the classification is hierarchized,
the classification unit performs the classification in each level with respect to the feature value vector extracted by the feature value extraction unit, and
the keyword assignment unit comprises a classification selection unit configured to select classification in any level from the classification classified by the classification unit in accordance with the frequency measured by the classification frequency measurement unit.

7. The apparatus according to claim 1, wherein
the frequency is one of number of feature value vectors belonging to the classification classified by the classification unit and a ratio of the number of feature value vectors belonging to the classification classified by the classification unit with respect to number of feature value vectors in all images already subjected to the classification.

8. The apparatus according to claim 1, further comprising a display control unit configured to display the input image together with keywords assigned by the keyword assignment unit.

9. A recording medium which records therein in a non-transitory manner:
a code which allows a computer to extract a feature value vector, which consists of feature values, from an input image;
a code which allows the computer to perform classification with respect to the extracted feature value vector;
a code which allows the computer to measure a frequency of the classified classification; and
a code which allows the computer to assign keywords to the input image based on the classified classification and the measured frequency.
